(19) United States
(12) Patent Application Publication
(10) Pub. No.: US 2007/0282825 A1
(43) Pub. Date: Dec. 6, 2007

(54) Systems and methods for dynamic content linking

(75) Inventor: Stephen H. Toub, New York, NY (US)

Correspondence Address: MICROSOFT CORPORATION, ONE MICROSOFT WAY, REDMOND, WA, 98052-6399, US

(73) Assignee: Microsoft Corporation Microsoft Patent Group, Redmond, WA (US)

(21) Appl. No.: 11/444,992

(22) Filed: Jun. 1, 2006

(51) Int. Cl. G06F 17/30

(52) U.S. Cl. 707/5

(57) ABSTRACT

Techniques and technologies are provided which can provide other information to a browser that is relevant to particular information within a web page comprising content. These techniques and technologies can be implemented as part of a system which comprises a browser running on a computer, a first information source and possibly other information sources. The first information source transmits content to the browser responsive to a request from the browser. The browser or the first information source can determine, responsive to a trigger, relevant information associated with the particular information as a user reviews different portions of the information within the content. The relevant information changes dynamically as the user reviews the different portions of the information. Either the first information source or another information source can then dynamically provide the relevant information to the browser based on the particular information being reviewed by the user while the user continues to review the content.

### BACKGROUND

This description relates generally to displaying content on a web page or a web site.

Many content-driven web sites attempt to keep users using their web site by surrounding content within their web page with “related” links to additional content. For example, many sites fill a box with links related to the overall theme of the current web page/site (e.g., other links which the user might be interested in viewing/visiting based on the theme of the web page the user is currently visiting). Some site operators manually search for and select other links which they perceive as being related to the main content of the web page/site being viewed by the user. Relevant links may also be generated via a periodic search for related articles in a database of articles maintained on the web page/site. Other web sites may employ a personalization engine which tracks a user's interactions with the site in order to infer interests, and uses that history to predict other content in which the user might be interested. The web site operator can then provide links which the operator thinks the user would like based on the user's previous history with the web page/site.

One drawback of these approaches is that the related links are typically related to the entire content of the article, or to specific sections analyzed before the user views the web page. However, content subject matter in many web pages is not continuous throughout the web page. In other words, particular portions of the content (e.g., individual paragraphs, sentences or words, etc.) in a web page may have no relationship to the related links provided on the web page. For example, other relevant or related content which a user may be interested in can depend, for example, on which part of the web page/site (e.g., which paragraph, sentence, or word) the user is currently reading, on which parts of the web page the user has previously read in the web page/site, etc. Moreover, the content that is relevant or related to the particular content can frequently change as new content is generated and posted on the Internet. As such, the related links which are provided to the user's browser along with the web page/site may lack relevance to the user's current interests or may not be the most up-to-date content related to the user's current interests, thus losing value in terms of user retention.

### SUMMARY

Techniques and technologies are provided which can allow for contextual analysis of particular content within a web site or web page that a user is currently reviewing via a browser. Links to other content related to the particular content of the web page can be asynchronously generated based on the particular content the user is presently focusing upon. As used herein, the terms “asynchronous ” and “asynchronously” refer to operations that happen independently from other operations taking place at the same time, typically background tasks running while normal operation of a foreground task continues. As the user reviews different portions of the content within the web page/site, asynchronous interaction between a browser running on a client-side computer and a server-side information source (e.g., the original content server, another content server, or other server-side information source) can allow searches to be performed to dynamically generate content (e.g., hyperlinks) relevant to the user's current focus. As such, information that is relevant to particular information the user is currently focusing upon (within the web page/site) can be dynamically provided to the user as the user reviews particular content within the web page/site.

These techniques and technologies can be implemented as part of a system which comprises a browser running on a computer, a first information source and possibly other information sources. The first information source transmits content to the browser responsive to a request from the browser. The browser or the first information source can determine, responsive to a trigger event, relevant information associated with particular information a user reviews as the user reviews different portions of information within the content. The relevant information changes dynamically as the user reviews the different portions of the information. Either the first information source or another information source can then dynamically provide the relevant information to the browser based on the particular information being reviewed by the user while the user continues to review the information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The techniques and technologies for dynamically providing information to a browser are further described with reference to the accompanying drawings in which:

FIG. 1 is a schematic diagram of an exemplary networked or distributed computing environment;

FIG. 2 is a schematic diagram of another exemplary networked or distributed computing environment;

FIG. 3 is a schematic diagram of another exemplary networked or distributed computing environment;

FIG. 4 is a flow chart showing exemplary techniques for dynamically providing information to a browser that is relevant to particular information or content within a web page that browser is presently displaying; and

FIG. 5 is a flow chart showing other exemplary techniques for dynamically providing information to a browser that is relevant to particular information or content within a web page that browser is presently displaying.

### DETAILED DESCRIPTION

The following detailed description is merely exemplary in nature and is not intended to limit the invention or the application and uses of the invention. As used herein, the word “exemplary” means “serving as an example, instance, or illustration.” Any implementation described herein as “exemplary” is not necessarily to be construed as preferred or advantageous over other implementations. All of the implementations described below are exemplary implementations provided to enable persons skilled in the art to make or use the invention and are not intended to limit the scope of the invention which is defined by the claims.

### Exemplary Networked and Distributed Environments

One of ordinary skill in the art can appreciate that the invention can be implemented in connection with any computer or other client or server device, which can be deployed as part of a computer network, or in a distributed computing environment. In this regard, the present invention pertains to any computer system or environment having any number of memory or storage units, and any number of applications and processes occurring across any number of storage units or volumes, which may be used in connection with the techniques and technologies disclosed herein. The techniques and technologies disclosed herein may apply to an environment with server-side computers and client-side computers deployed in a network environment or distributed computing environment, having remote or local storage. The present invention may also be applied to standalone computing devices, having programming language functionality, interpretation and execution capabilities for generating, receiving and transmitting information in connection with remote or local services.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise.

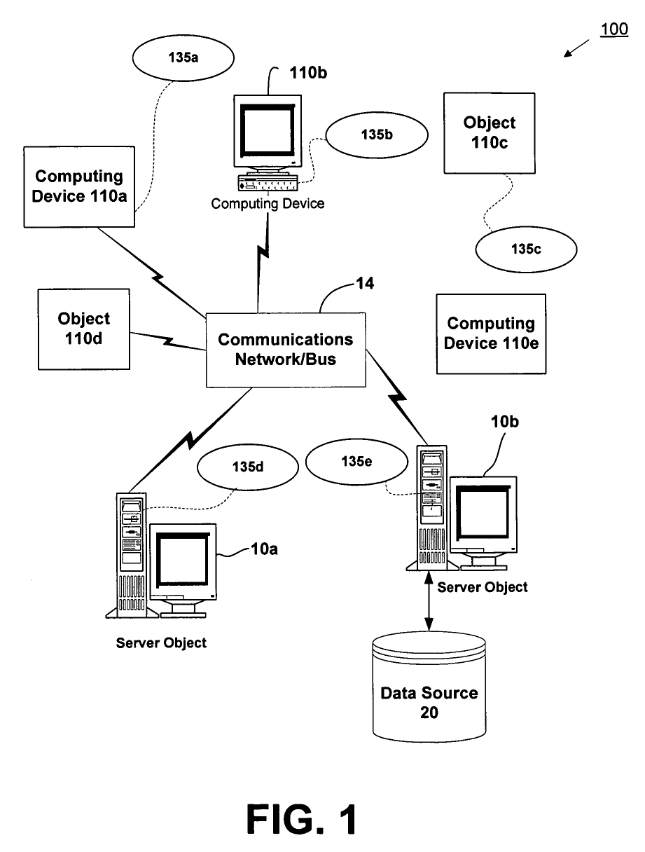

FIG. 1 is a schematic diagram of an exemplary networked or distributed computing environment 100 comprising computing objects 10a, 10b, etc. and computing objects or devices 110a, 110b, 110c, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 14. This network may itself comprise other computing objects and computing devices that provide services to the system of FIG. 1, and may itself represent multiple interconnected networks.

It can also be appreciated that an object, such as 110c, may be hosted on another computing device 10a, 10b, etc. or 110a, 110b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge as protocol standards may be interconnected to form a network, such as an intranet, that may be connected to the outside world by way of the Internet. In short, a variety of disparate sources exist for the storage and transmission of data, and consequently, computing devices require ways of sharing data, such as data accessed or utilized incident to program objects.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over the network(s). Because of such wide-spread information sharing, remote networks such as the Internet have thus far generally evolved into an open system for which developers can design software applications for performing specialized operations or services, essentially without restriction.

Thus, the network infrastructure enables a host of network topologies such as client/server, peer-to-peer, or hybrid architectures.

A “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 1, computers 110a, 110b, etc. can be thought of as clients and computers 10a, 10b, etc. can be thought of as the server where server 10a, 10b, etc. maintains the data that is then replicated in the client-side computers 110a, 110b, etc., although, depending on the circumstances, any computer can be considered a client, a server, or both. Any of these computing devices may be processing data or requesting services or tasks that may implicate techniques and technologies specific to an implementation of the invention.

A server is typically a remote computer system accessible over a remote or local network, such as the Internet, though a server process may also reside on the same machine as the client process. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the disclosed technologies and techniques may be distributed across multiple computing devices or objects.

Client(s) and server(s) typically communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server-side or client-side computers to each other. The network address can be referred to as a URL address. Communication can be provided over a communications medium, e.g., client(s) and server(s) may be coupled to one another via TCP/IP connection(s) for high-capacity communication.

Thus, FIG. 1 illustrates an exemplary networked or distributed environment 100, with a server in communication with client-side computers via a network/bus. In more detail, a number of servers 10a, 10b, etc., are interconnected via a communications network/bus 14, which may be a LAN, WAN, intranet, the Internet, etc., with a number of client or remote computing devices 110a, 110b, 110c, 110d, 110e, etc., such as a portable computer, handheld computer, thin client, networked appliance, or other device.

In a network environment in which the communications network/bus 14 is the Internet, for example, the servers 10a, 10b, etc. can be Web servers with which the clients 110a, 110b, 110c, 110d, 110e, etc. communicate via any of a number of known protocols such as HTTP. Servers 10a, 10b, etc. may also serve as clients 110a, 110b, 110c, 110d, 110e, etc., as may be characteristic of a distributed computing environment. Communications may be wired or wireless, where appropriate. Client devices 110a, 110b, 110c, 110d, 110e, etc. may or may not communicate via communications network/bus 14, and may have independent communications associated therewith. Each client-side computer 110a, 110b, 110c, 110d, 110e, etc. and server computer 10a, 10b, etc. may be equipped with various application program modules or objects 135 and with connections or access to various types of storage elements or objects, across which files or data streams may be stored or to which portion(s) of files or data streams may be downloaded, transmitted or migrated. Any one or more of computers 10a, 10b, 110a, 110b, etc. may be responsible for the maintenance and updating of a data source 20 or other storage element, such as a database or memory 20. Thus, the computer network environment can include client-side computers 110a, 110b, etc. that can access and interact with a computer network/bus 14 and server computers 10a, 10b, etc. that may interact with client-side computers 110a, 110b, etc. and other like devices, and data sources 20.

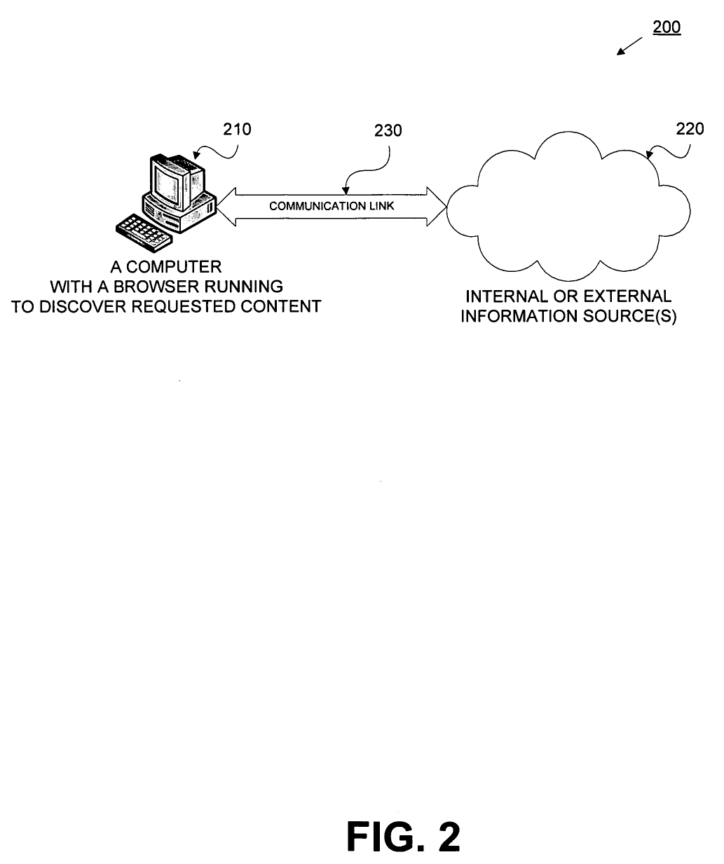

FIG. 2 is an exemplary networked or distributed computing environment 200 comprising a client-side computer 210 having a browser application running thereon and a server-side information source 220 which communicates with the client-side computer 210 over a wired or wireless communication link 230. In the example shown in FIG. 2, the server-side information source 220 may be an internal server-side information source located within the client-side computer 210 (that is running the browser application) or an external server-side information source, such as a content server that is part of an external network such as an intranet, the Internet, etc.

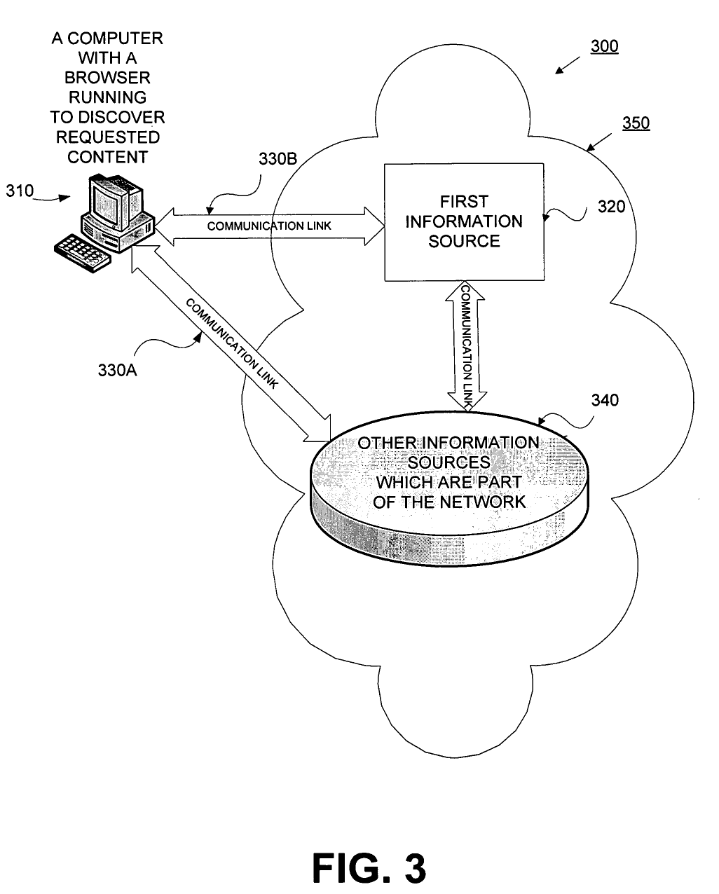

FIG. 3 is an exemplary networked or distributed computing environment 300 comprising a client-side computer 310 having a browser application running thereon, and a network 350 comprising a first external server-side information source 320 and other external server-side information sources 340 which communicate with the client-side computer 310 over a wired or wireless communication link 330B. In the example shown in FIG. 3, the server-side information sources 320, 340 may comprise, for example, content servers that are part of an external network 350 such as an intranet, the Internet, etc.

While certain functionality or steps are described below as being performed or occurring at the client-side (e.g., a computer running a browser), it will be appreciated that the certain functionality or steps could also be performed or occur at the server-side (e.g., the information source, server or content server). Similarly, while other functionality or steps are described below as being performed or occurring at the server-side (e.g., the information source, server or content server), it will be appreciated that the other functionality or steps could also be performed or occur at the client-side (e.g., a computer running a browser).

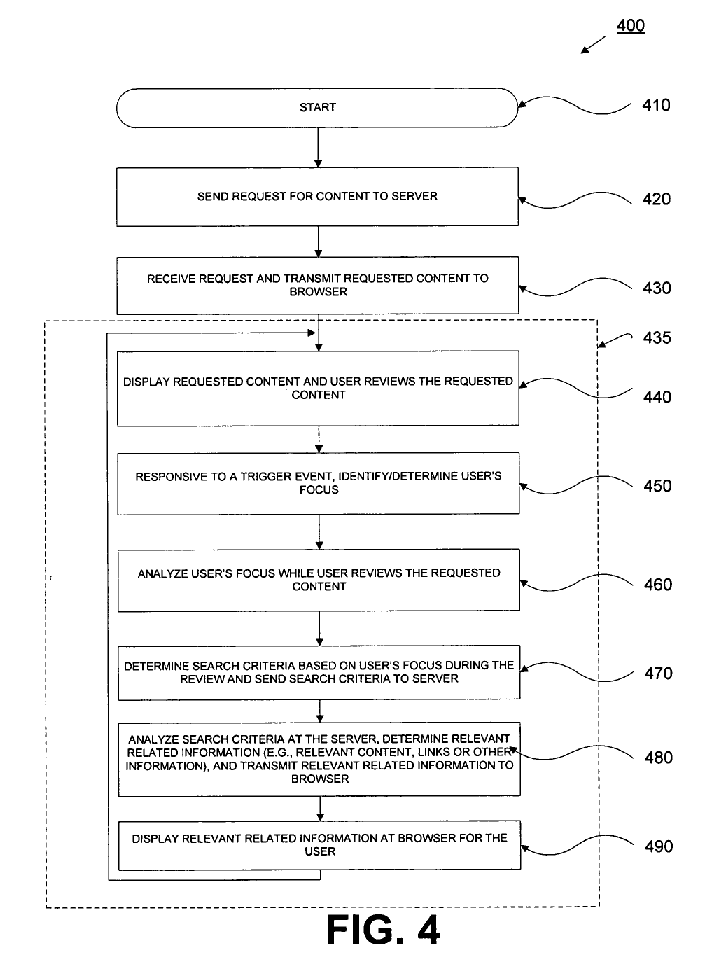

FIG. 4 is a flow chart showing exemplary techniques 400 for providing information to a browser that is relevant to particular information or content within a web page that browser is presently displaying. The content comprises information, such as text, hyperlinks, and media such as images, pictures, drawings, other types of visible content which can be displayed to the user, and, other types of content which are not displayed to the user, such as markup and metadata. The flow 400 is described below as taking place at the client-side computer or at a server-side information source, however, it will be appreciated that the different logical steps in the flow can occur in other ways than shown in this particular implementation.

The process starts at step 410, and at step 420 a browser running on a computer transmits a request for content to a first server-side information source. At step 430, upon receiving the request from the browser, the first server-side information source transmits the requested content (e.g., a web page) to the browser, and the browser displays the requested content. As a user reviews particular information or content in the web page, the particular content changes dynamically based on interactions the user has had with the web page.

At step 435 (shown with dotted line rectangle), either the first server-side information source or the browser can determine, responsive to the trigger event, relevant information associated with the particular information the user is reviewing as a user reviews different portions of the information within the content of the web site. The relevant information changes dynamically as the user reviews the different portions of the information. The relevant information can be dynamically provided to the browser based on the particular information being reviewed by the user while the user continues to review the information. The relevant information can be dynamically provided from the first server-side information source (that transmitted the original content requested by the user), an internal information source (e.g., a client-side desktop search application, a custom object that query the contents of a user's browsing history, etc.) within the computer that is running the browser application, or another server-side information source (e.g., an external server-side information source, such as a content server that is part of an external network such as an intranet, the Internet), etc. As noted above, the relevant information (that is dynamically provided to the browser) changes based on the particular information being reviewed by the user at a particular time. In one implementation, the relevant information can be determined via steps 440 through 490, as will now be described below.

At step 440, the browser displays the requested content to the user and a user reviews a first portion of the requested content. As the user reviews the first portion of the requested content, different triggers or trigger events take place. The triggers can comprise, for example, an event driven trigger; a timer driven trigger; and a combined event/timer driven trigger.

For instance, in some implementations, the trigger can be event driven. For example, the user's focus can be analyzed any time the mouse pointer moves to a new position or hovers over a particular word or sentence or paragraph for a set period of time, any time the content in the browser scrolls, when the user selects any of the text in the web page, any time the browser application loses focus by the user switching to a different application, etc.

In other implementations, the trigger can be timer driven. For example, the user's focus can be reanalyzed based on current browser state every time the timer fires, which could be a predetermined amount of time or could be a dynamically chosen amount of time based on the user's interaction model (e.g., scrolling quickly through the content vs. reading slowly, reading quickly through certain sections and then pausing significantly longer to read others, etc.)

Other implementations can incorporate both the event-driven and timer-driven techniques.

At step 450, a focus of the user can be identified or determined. The specific techniques used to determine or identify the user's focus are implementation-dependent can be based on any number of techniques and algorithms. For instance, in one implementation, the browser can determine or identify the user's focus based on mouse position, current scroll position, currently selected text, or any other mechanism for tracking which part of the web page the user is currently focused upon. In one implementation, the focus of the user can be analyzed as the user reviews a first portion of the requested content. Alternatively, the focus of the user can be analyzed based on other portions of the requested content the user has reviewed. For example, the server could have previously sent new content down to the client, and the client could be focusing on that new material. If the user focuses on that content for long enough, the server can send the user more specific content related to that new content even though that content is not part of the first portion of the requested content but was sent down as a later portion.

At step 460, the focus of the user can be analyzed as the user reviews the requested content. There are numerous techniques for analyzing the user's focus to determine search criteria that relate to the user's focus, ranging from simple techniques such as word frequency analysis to more complex techniques including grammatical analysis. For example, in one implementation, the browser can use document summarization and analysis technologies to analyze the current text the user is reviewing and generate appropriate search criteria. In another implementation, appropriate search criteria can be extracted, for instance, from the browser's Document Object Model by determining contextual keywords related to the user's current focus, information about the whole web page, information about the user's browsing history, and any number of other sources which characterize the user's current focus.

At step 470, the browser determines search criteria based on the focus of the user as the user continues to review the first portion of the requested content. In one implementation, the search criteria information can include contextual keywords related to the user's current focus, information about the whole web page, information about the user's browsing history, and any number of other sources. In another implementation, the search criteria could be the exact text under the user's focus, such as an entire paragraph of text selected by the user.

At step 480, a server-side analyzes the search criteria to determine relevant related information, and transmits the relevant related information to the browser for display to the user while the user is reviewing the requested content. The relevant related information comprises relevant content (e.g., relevant links, relevant text to display in a secondary window such as a pop-up, relevant diagrams, etc.).

At step 490, the browser displays the relevant related information to the user while the user is reviewing the requested content. As indicated by the loop, steps 440-480 are repeated as the user reviews different information within the requested content so that the relevant related information can be continuously updated for the user.

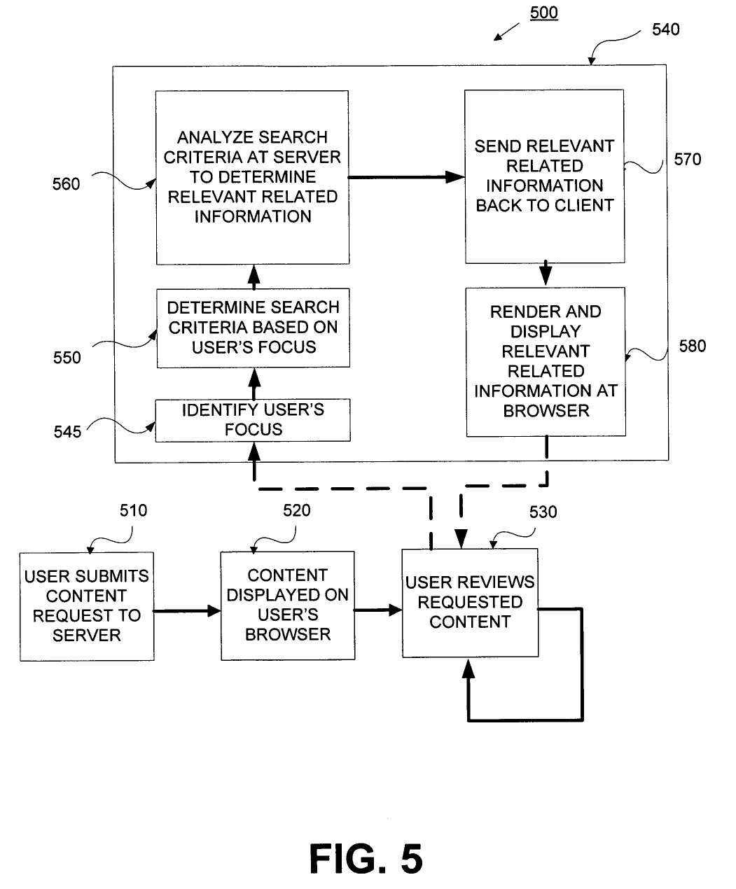

FIG. 5 is an exemplary flow chart 500 showing exemplary techniques for providing other relevant information to a browser that is relevant to particular information or content within a web page that browser is presently displaying.

At step 510, a user sends a content request to request content from a content server. At step 520, the content server retrieves the requested content, and sends it to the browser of the client-side computer where the requested content is displayed. At step 530, the user starts reviewing particular portions of the requested content. At step 540, the content server can asynchronously determine other relevant related information which is relevant to the particular content the user is reviewing within the requested content, and can then send the relevant related information back to the browser of the client-side computer. This determination of step 540 can be made via steps 550 through 580.

At step 545, the context or object of the user's focus can be determined or identified at either the client-side computer, the browser of the client-side computer or the content server. The specific techniques used to determine or identify the user's focus are implementation-dependent and can be based on any number of techniques and algorithms. For instance, in one implementation, the browser can determine or identify the user's focus based on mouse position, current scroll position, currently selected text, or any other mechanism for tracking which part of the web page the user is currently focused upon. For example, if the mouse is currently hovering over the word “DataGrid” and if the article is about ASP.NET, then links to articles covering the ASP.NET DataGrid might be retrieved. Alternatively, if the user has selected a paragraph of text (with an input device such as a mouse, scroll pad, keyboard, an electromagnetic digitizer pen, etc.) that contains frequent references to Windows Forms, links to articles related to Windows Forms (and possibly Windows Forms in the context of ASP.NET, for example ASP.NET applications that make use of page-embedded Windows Forms controls) could be retrieved even though the article itself might be focusing on something completely different or-much more general, like ASP.NET.

At step 550, once the user's focus has been determined or identified, the user's “focus” can be analyzed to determine search criteria (e.g., distilled into appropriate search terms) that can then be sent to the content server. There are numerous techniques for analyzing the user's focus to determine search criteria that relate to the user's focus. Some exemplary techniques are described above with reference to step 460 of FIG. 4.

The input to the analysis techniques is also not limited to the content retrieved from the retrieval phase. Other inputs, such as the user's browsing history (if available), the amount of time they spent reading various portions of the current article, etc., could be used to influence what search terms are created. In addition to search terms, the system can also create more structured queries; for example, if it determines that the current focus has multiple related terms, it might create a query that requires both terms, versus a situation in which it determines that the current focus has multiple unrelated terms, in which case the query might allow for either term to be present.

It will be appreciated that the functionality described above with respect to steps 545 and 550 is not limited to a client-side implementation. It could be implemented on the client, with access to any information available from the browser, or it could be a server-side implementation, with all of the data retrieved from the browser being supplied to the server. In such a server-side scenario, the analysis could include information gained from users other than the current user, including ratings information as submitted by users, page view frequencies, page transitions stats, and so on. The analysis phase could also be implemented as a combination of client-side and server-side components. For example, the client could distill the “focus” into some recommended search terms based on its client-side knowledge, and this information, along with the original focus text, could be sent to the server, where the terms or search criteria would be further refined based on server-side knowledge.

In one implementation, the search criteria information can include contextual keywords related to the user's current focus, information about the whole web page, information about the user's browsing history, and any number of other sources, 'and the server can analyze this search criteria information.

When the search criteria information has been retrieved from the browser and any other client sources, the search criteria information is submitted to the server. This can be done using any out-of-band techniques. According to one implementation, the browser can use an Asynchronous JavaScript and XML (AJAX) implementation to make an asynchronous request to the server. As known by those skilled in the art, applications created with AJAX techniques typically combine several programming tools including JavaScript, dynamic HTML (DHTML), Extensible Markup Language (XML), cascading style sheets (CSS), the Document Object Model (DOM), and the Microsoft object, XMLHttpRequest. When a user performs an action, such as clicking on an element in a Web page, rather than blocking the user and forcing them to wait for the server to respond, AJAX allows the user to continue accessing the Web page while the operation and request resulting from the user's action are performed in the background. This asynchronous request could be made, for example, to an XML Web service, an ASP.NET page, or any other acceptable target. Results retrieved and processed from the target of the request can then be used to update the Web page without forcing or requiring a full page refresh.

Regardless of the method of transmission, the client-side request, which comprises the search criteria information, is sent to the server. Upon receiving the request from the client-side computer which hosts the browser, at step 560, a server-side service (e.g., the server-side information source or server to which the data is sent) can analyze or process the search criteria information to determine relevant related information to send back to the client. In analyzing the search criteria information, the server-side service can, for example, search a data source of content in order to find links to related articles, perform definition lookups in order to find definitions of selected terms, and so forth. It will be appreciated that the server-side information source or server to which the data is sent does not necessarily have to be the server that initially served the content. For example, Web services provided by Web search engines could be used to perform the search, with the client page sending the information to that search engine and processing its results rather than sending the information to the original content server.

In one implementation, the relevant related information comprises data about what relevant information should be sent back to the user. The relevant related information can include content and/or links which are related to the particular content the user is reviewing within the requested content. For example, the relevant related information may comprise links to other content related to the user's current focus, or other related information, such as descriptions of those links, definitions of terms in the selected text, and so forth.

At step 570, the relevant related information can be sent back to the client-side computer. For example, relevant links or other information can then be sent back to the browser out-of-band. This can allow the content server to asynchronously present relevant related material to the user (via the browser) without the user ever leaving the web page the user is reading or even being aware that these searches are being done on his or her behalf. From the user's perspective, as the user reads through the content on the web page, it will appear to the user that he is just reading along and that new relevant information is being displayed as he or she does so.

Upon receipt of the relevant related information from the server, at step 580, the browser displays or renders the relevant related information on the browser of the client-side computer in an application specific fashion. Based on what the system perceives as the user's current interests, the user can be continuously presented with new relevant related information (e.g., hyperlinks or other information) that is relevant to what the user has previously read or is currently reading, focusing on, or what the user might read next. The particular details regarding how the browser uses and renders the relevant related information retrieved from the server are highly implementation dependent. This could include, for example, rendering the relevant related information with the current content, for example, next to the current content in a side panel, hovering the information transparently on top of the current content or above the user's current focus, as a pop-up window, or using any of a number of other techniques available in the browser.

In addition to showing the last relevant related information retrieved, the client-side computer can also cache the relevant related information and can choose to show the current information along with any previous relevant related information retrieved. For example, the client could maintain a list of the last X number of links retrieved, display those links, and as new links are received from the server, they can be added to the list, bumping older links out of the list to maintain the X number of links most recently received.

Thus, the techniques and technologies described above can be used to provide related relevant content that varies dynamically based on the particular content a user is currently reviewing within a web page/site. The user's current focus is taken into account when presenting the user with relevant related content which can change as the user's focus changes while viewing the web page/site.

The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical. Furthermore, numerical ordinals such as “first,” “second,” “third,” etc. simply denote different singles of a plurality and do not imply any order or sequence unless specifically defined by the claim language.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, the server can take advantage of personalization support that might already exist on the server for computing the relevant related information, and the server can also take into account the information being sent by the browser. In addition, in other implementations, a feedback mechanism can be provided whereby the browser makes asynchronous requests to the server when a user follows one of the dynamically generated links. The server can track which dynamically-generated links were clicked after being presented for specific focuses. The server can then use that information when making future decisions about what links to send back to the client, both for the current user when reading other pages, and for future users when browsing the site in general.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiments and implementations.

It should also be understood that various changes can be made in the function and arrangement of elements without departing from the scope of the invention as set forth in the appended claims and the legal equivalents thereof. As such, we claim as our invention all such embodiments as may come within the scope and spirit of the following claims and equivalents thereto. Thus, the present invention is not intended to be limited to the embodiments shown herein but is to be accorded the widest scope consistent with the principles and novel features disclosed herein.

What is claimed:

1. A method, comprising:
transmitting content from a first information source responsive to a request from a browser running on a computer, wherein the content comprises information;
determining relevant information associated with the particular information being reviewed by a user as the user reviews different portions of the information within the content, wherein the relevant information changes dynamically as the user reviews the different portions of the information; and
providing the relevant information to the browser from an information source based on the particular information being reviewed by the user while the user continues to review the content.

2. A method according to claim 1, wherein providing the relevant information to the browser from the information source based on the particular information being reviewed by the user, further comprises:
displaying a first portion of the requested content to the user.

3. A method according to claim 1, wherein providing the relevant information to the browser from the information source based on the particular information being reviewed by the user, further comprises:
analyzing a focus of the user as the user reviews a portion of the requested content.

4. A method according to claim 3, wherein the content comprises a web page, and wherein the focus comprises particular information within the web page that is being reviewed by the user.

5. A method according to claim 3, wherein the content comprises a web page, and wherein the focus comprises particular information within the web page.

6. A method according to claim 3, wherein providing the relevant information to the browser from the information source based on the particular information being reviewed by the user further comprises:
determining search criteria based on the focus of the user.

7. A method according to claim 6, wherein providing the relevant information to the browser from the information source based on the particular information being reviewed by the user further comprises:
transmitting the search criteria to the information source.

8. A method according to claim 7, wherein providing the relevant information to the browser from the information source based on the particular information being reviewed by the user further comprises:
analyzing the search criteria to determine relevant related information; and
transmitting the relevant related information to the browser for display to the user while the user is reviewing the requested content.

9. A method according to claim 8, wherein the relevant related information comprises relevant content.

10. A method according to claim 9, wherein the relevant content comprises at least one hyperlink relevant to the content.

11. A method according to claim 8, wherein providing the relevant information to the browser from the information source based on the particular information being reviewed by the user further comprises:
displaying the relevant related information to the browser for display to the user while the user is reviewing the requested content.

12. A method according to claim 9, wherein providing the relevant information to the browser from the information source based on the particular information being reviewed by the user further comprises:
repeating the steps recited in claim 1 as the user reviews different information within the requested content.

13. A method according to claim 1, wherein the trigger comprises at least one of:
an event driven trigger;
a timer driven trigger; and
a combined event/timer driven trigger.

14. A method according to claim 1, wherein the first information source determines relevant information associated with the particular information, responsive to the trigger, as a user reviews different portions of the information within the content.

15. A method according to claim 1, wherein the browser determines relevant information associated with the particular information, responsive to the trigger, as a user reviews different portions of the information within the content.

16. A method according to claim 1, wherein the information source comprises the first information source.

17. A method according to claim 1, wherein the information source comprises an internal information source within the computer that is running the browser application.

18. A method according to claim 1, wherein the information source comprises a content server that is part of an external network.

19. A browser running on a computer, comprising:
a first module configured to transmit a request for content, wherein the content comprises information;
a second module configured to receive the request content from a first information source responsive to the request;
a graphical user interface configured to display the requested content; and
a third module configured to determine, responsive to a trigger, relevant information associated with the particular information as different portions of the information within the content are being reviewed, wherein the relevant information is relevant to the particular information and changes dynamically as the different portions of the information are being reviewed; and
wherein the second module is further configured to dynamically receive the relevant information based on the particular information being reviewed as the information continues to be reviewed.

20. A first information source, comprising:
a first module configured to:
transmit content to a browser running on a computer responsive to a request from the browser, and
dynamically transmit relevant information to the browser based on particular information being reviewed within a web page while information within the web page continues to be reviewed, wherein the web page comprises content, wherein the content comprises information,
wherein the relevant information comprises information that is relevant to the particular information within the web page, and wherein the relevant information associated with the particular information changes dynamically as different portions of the information are being reviewed.
a second module configured to determine, responsive to a trigger, relevant information associated with the particular information as different portions of the information within the content are being reviewed,
wherein the relevant information is relevant to the particular information within the web page and changes dynamically as the different portions of the information are being reviewed.
